(19) United States
(12) Patent Application Publication
(10) Pub. No.: US 2026/0178981 A1
(43) Pub. Date: Jun. 25, 2026

(54) SEARCH DEVICE, SEARCH METHOD, AND PROGRAM

(71) Applicant: Panasonic Intellectual Property Management Co., Ltd., Osaka (JP)

(72) Inventors: RYO MIYA, Osaka (JP); HIROAKI YOSHIDA, Osaka (JP); TAICHI NAKAMURA, Osaka (JP)

(21) Appl. No.: 19/535,268

(22) Filed: Feb. 10, 2026

Related U.S. Application Data
(63) Continuation of application No. PCT/JP2024/023825, filed on Jul. 1, 2024.

(30) Foreign Application Priority Data
Sep. 11, 2023 (JP) 2023-147164

(51) Int. Cl. G06N 20/00; G06F 16/9535; G06N 7/01

(52) U.S. Cl. CPC G06N 20/00; G06F 16/9535; G06N 7/01

(57) ABSTRACT

Search device (100) includes data set update unit (110) that generates or updates data set (121) indicating target variable y and explanatory variable x in association with each other, confidence value calculation unit (130) that calculates confidence value r of target variable y based on process data obtained from material processing apparatus (200), the process data indicating a state of a raw material during processing, data set processing unit (140) that processes data set (121) based on confidence value r, prediction model generation unit (150) that generates prediction model (123) by using processed data set (122) that is data set (121) that is processed, the prediction model indicating a relationship between explanatory variable x and target variable y, and search condition derivation unit (160) that derives a value of explanatory variable x for obtaining a target value of target variable y as a search condition, the deriving being performed by a search using prediction model (123).

### TECHNICAL FIELD

The present disclosure relates to a search device that searches for a condition used for processing of a raw material, and the like.

### BACKGROUND ART

A material processing apparatus such as a chemical reactor and a semiconductor processing apparatus generates a product by performing processing such as synthesis and processing of a raw material according to a processing condition. A characteristic value of the product varies depending on various processing conditions of the material processing apparatus. For example, a characteristic value of a product is obtained for each of a plurality of mutually different processing conditions. Here, in order to obtain a product having a target characteristic value, it is necessary to search for an input parameter from which an output parameter indicating the target characteristic value is obtained from a plurality of input parameters indicating mutually different values as processing conditions. However, it is not realistic to actually measure or evaluate an output parameter for each of all input parameters. For this reason, a search for an optimal solution of an input parameter is performed using a method based on machine learning such as a neural network.

PTL 1 discloses a search device that generates a prediction model indicating a relationship between an input parameter and an output parameter by machine learning and searches for an optimal solution based on the prediction model. Specifically, the search device of PTL 1 obtains, as a predicted value, a value of an input parameter from which an output parameter indicating a target characteristic value is obtained based on a prediction model, and determines whether or not an actually measured value corresponding to the predicted value reaches a target. Note that the actually measured value is an actually measured characteristic value of a product obtained by processing according to a predicted value by a semiconductor processing apparatus. Then, when the actually measured value does not reach the target, the search device updates the prediction model by adding the predicted value and the actually measured value to training data as a new input parameter and a new output parameter. As a result, search efficiency is improved. Furthermore, when the actually measured value is not close to the target, the search device of PTL 1 excludes a region where a combination of the actually measured value and the predicted value exists from a search region. By the above, accuracy of reaching an optimum solution is improved.

### CITATION LIST

### Patent Literature

PTL 1: Unexamined Japanese Patent Publication No. 2019-40984

### SUMMARY OF THE INVENTION

A search device according to a first aspect of the present disclosure includes a data set update unit that generates or updates a data set indicating a target variable and an explanatory variable in association with each other, the target variable indicating a characteristic value of a product obtained by processing by a material processing apparatus performed on a raw material according to the explanatory variable, a confidence value calculation unit that calculates a confidence value of the target variable based on process data obtained from the material processing apparatus, the process data indicating a state of the raw material during the processing, a data set processing unit that processes the data set based on the confidence value, a prediction model generation unit that generates a prediction model by using a processed data set that is the data set that is processed, the prediction model indicating a relationship between the explanatory variable and the target variable, and a search condition derivation unit that derives, as a search condition, a value of the explanatory variable for obtaining a target value of the target variable, the deriving being performed by a search using the prediction model.

Note that these comprehensive or specific aspects may be implemented by a system, a method, an integrated circuit, a computer program, or a recording medium such as a computer-readable CD-ROM, or may be implemented by any combination of the system, the method, the integrated circuit, the computer program, and the recording medium. Further, the recording medium may be a non-transitory recording medium.

Note that further advantages and effects of one aspect of the present disclosure will become clear from the description and drawings. Such advantages and/or effects are provided by the configuration described in some exemplary embodiments and the description and drawings, but not necessarily all configurations are required.

### BRIEF DESCRIPTION OF THE DRAWINGS

FIG. 1 is a diagram illustrating an example of a search system according to an exemplary embodiment.

FIG. 2 is a block diagram illustrating an example of a configuration of a material processing apparatus according to the exemplary embodiment.

FIG. 3 is a block diagram illustrating an example of a configuration of a search device according to the exemplary embodiment.

FIG. 4A is a diagram for describing a relationship between process data and a prediction model.

FIG. 4B is a diagram for describing another relationship between process data and a prediction model.

FIG. 5 is a diagram illustrating an example of a data set according to the exemplary embodiment.

FIG. 6 is a diagram illustrating an example of process abnormality degree according to the exemplary embodiment.

FIG. 7 is a diagram illustrating an example of confidence value and a ratio of confidence value according to the exemplary embodiment.

FIG. 8 is a diagram for describing weighting of a training amount according to the exemplary embodiment.

FIG. 9 is a diagram for describing a target variable included in an additional combination according to the exemplary embodiment.

FIG. 10 is a diagram illustrating an example of a processed data set according to the exemplary embodiment.

FIG. 11 is a diagram for describing an example of processing by a prediction model generation unit according to the exemplary embodiment.

FIG. 12 is a diagram for describing a search using a prediction model according to the exemplary embodiment.

FIG. 13 is a flowchart illustrating an example of processing operation of the search device according to the exemplary embodiment.

### DESCRIPTION OF EMBODIMENT

### (Knowledge Underlying Present Invention)

With respect to PTL 1 described above in the section of “BACKGROUND ART”, the present inventor has found that there is a problem that an efficient search cannot be performed in some cases as follows.

The search device of PTL 1 updates or generates a prediction model by using a characteristic value of a product obtained by processing in the semiconductor processing device as an output parameter regardless of whether or not the processing is stable. Here, an output parameter obtained by stable processing is highly reliable, but an output parameter obtained by unstable processing is less reliable. When such an output parameter with low reliability is used as training data for generating a prediction model using machine learning such as a neural network, an erroneous prediction model is generated. As a result, by using such a prediction model, there is a possibility that an optimum solution cannot be reached or it takes a long time to reach an optimum solution. That is, efficient search becomes difficult to perform.

For example, conventionally, an apparatus having a flow path forming body, what is called a microreactor, is known as a material processing apparatus that brings liquids (that is, reactants) soluble in each other into contact with each other and mixes the liquids to cause the liquids to react with each other so as to produce a desired product. This microreactor generates a product by causing a plurality of types of liquid to be mixed to flow in a microchannel. Therefore, depending on a processing condition, a product may cause deposition, adhesion, channel blockage, and the like in the microchannel, and it may be difficult to achieve a stable reaction. Therefore, in a case where a search using the search device of PTL 1 is performed on such a material processing apparatus, there is a possibility that an efficient search becomes significantly difficult to perform.

The present disclosure provides a search device capable of performing an efficient search.

A search device according to a first aspect of the present disclosure includes a data set update unit that generates or updates a data set indicating a target variable and an explanatory variable in association with each other, the target variable indicating a characteristic value of a product obtained by processing by a material processing apparatus, the processing being performed on a raw material according to the explanatory variable, a confidence value calculation unit that calculates a confidence value of the target variable based on process data obtained from the material processing apparatus, the process data indicating a state of the raw material during the processing, a data set processing unit that processes the data set based on the confidence value, a prediction model generation unit that generates a prediction model by using a processed data set that is the data set that is processed, the prediction model indicating a relationship between the explanatory variable and the target variable, and a search condition derivation unit that derives, as a search condition, a value of the explanatory variable for obtaining a target value of the target variable, the deriving being performed by a search using the prediction model.

The search device of the present disclosure can efficiently perform a search. Specifically, data set is processed based on a confidence value of a target variable, and a prediction model is generated using the processed data set. For this reason, for example, influence of a value of a target variable having a small confidence value on generation of a prediction model can be suppressed, and influence of a value of a target variable having a large confidence value on generation of a prediction model can be increased. As a result, even when a process for processing a raw material is unstable, that is, even in a case where an unreliable value of a target variable is obtained, a prediction model with high prediction accuracy can be generated. As a result, even in such a case, it is possible to perform an efficient search for a value of an explanatory variable by using the prediction model. Further, a speed of a search can be increased.

Further, in the search device according to a second aspect, the prediction model generation unit may generate the prediction model by machine learning using the processed data set, and the data set processing unit may process the data set by weighting, according to the confidence value, a training amount that is the number of combinations of a value of the explanatory variable and a value of the target variable. Note that the second aspect may be dependent on the first aspect.

By the above, a training amount for generating a prediction model by machine learning is weighted according to a confidence value. For this reason, for example, influence of a value of a target variable having a small confidence value on machine learning can be suppressed, and influence of a value of a target variable having a large confidence value on machine learning can be increased. That is, overfitting with respect to a value of a target variable having a small confidence value can be suppressed. Therefore, a prediction model with high prediction accuracy can be appropriately generated by machine learning.

Further, in the search device according to a third aspect, the confidence value calculation unit may calculate, for each existing combination that is one of the combinations included in the data set, a confidence value of a value of the target variable based on the process data when a value of the target variable included in the existing combination is obtained, and the data set processing unit may weight the training amount by changing, according to the confidence value, the number of the combinations including a value of the explanatory variable corresponding to the confidence value for each confidence value. Note that the third aspect may be dependent on the second aspect.

By the above, the processed data set includes, for each existing combination included in a data set, additional combinations as many as the number according to a confidence value, each including the same value of an explanatory variable as the existing combination. As a result, since the number of combinations can be adjusted according to a confidence value, for example, influence of a value of a target variable having a small confidence value on the machine learning can be effectively suppressed, and influence of a value of a target variable having a large confidence value on the machine learning can be effectively increased. That is, overfitting with respect to a value of a target variable having a small confidence value can be effectively suppressed. Therefore, a prediction model with high prediction accuracy can be more appropriately generated by machine learning.

Further, in the search device according to a fourth aspect, the data set processing unit may include, when generating a plurality of new combinations from the existing combinations due to increase in the number of the combinations, a value different from a value of the target variable as a new value of the target variable, instead of the value of the target variable included in the existing combination, in each of at least one of a plurality of the new combinations. Note that the fourth aspect may be dependent on the second aspect or the third aspect.

By the above, for example, a value of a target variable having a small confidence value included in an existing combination is replaced with another value different from the value and included in a new combination. Therefore, overfitting with respect to the value of the target variable having the small confidence value can be more effectively suppressed.

Further, in the search device according to a fifth aspect, the confidence value calculation unit may calculate the confidence value indicating a smaller value as variation of a value indicated by the process data is greater, and the data set processing unit may change the number of the combinations by increasing the number of the combinations as the confidence value is larger. Note that the fifth aspect may be dependent on any one of the second to fourth aspects.

By the above, overfitting with respect to a target variable having a small confidence value can be effectively suppressed.

Further, in the search device according to a sixth aspect, the data set processing unit may select a new value of the target variable included in each of a plurality of the new combinations according to probability distribution having a value of the target variable included in the existing combination as an average. Note that the sixth aspect may be dependent on the fourth aspect or the fifth aspect.

By the above, a value of a target variable included in an existing combination can be appropriately replaced with another value different from the value and included in a new combination.

Further, in the search device according to a seventh aspect, the data set processing unit may use normal distribution as the probability distribution, and randomly select a new value of the target variable according to the normal distribution. Note that the seventh aspect may be dependent on the sixth aspect.

By the above, a value of a target variable included in an existing combination can be more appropriately replaced with another value different from the value and included in a new combination.

Further, in the search device according to an eighth aspect, the data set processing unit may use the normal distribution having smaller variance as the confidence value is larger. Note that the eighth aspect may be dependent on the seventh aspect.

By the above, for example, a value of a target variable having a small confidence value included in an existing combination can be replaced with another value greatly different from the value and included in a new combination, and a value of a target variable having a large confidence value can be replaced with another value close to the value and included in a new combination. Therefore, overfitting with respect to a value of a target variable having a small confidence value can be further effectively suppressed.

Hereinafter, an exemplary embodiment will be specifically described with reference to the drawings.

Note that the exemplary embodiment described below illustrates a comprehensive or specific example. Numerical values, shapes, materials, components, disposition positions and connection modes of the components, steps, order of the steps, and the like illustrated in the following exemplary embodiment are merely examples, and therefore are not intended to limit the present disclosure. Further, among components according to the following exemplary embodiment, those not recited in an independent claim representing the most superordinate concept will be described as optional components. Further, each of the drawings is a schematic diagram, and is not necessarily strictly illustrated. Further, in the drawings, identical reference marks are given to the same constituent members.

### Exemplary Embodiment

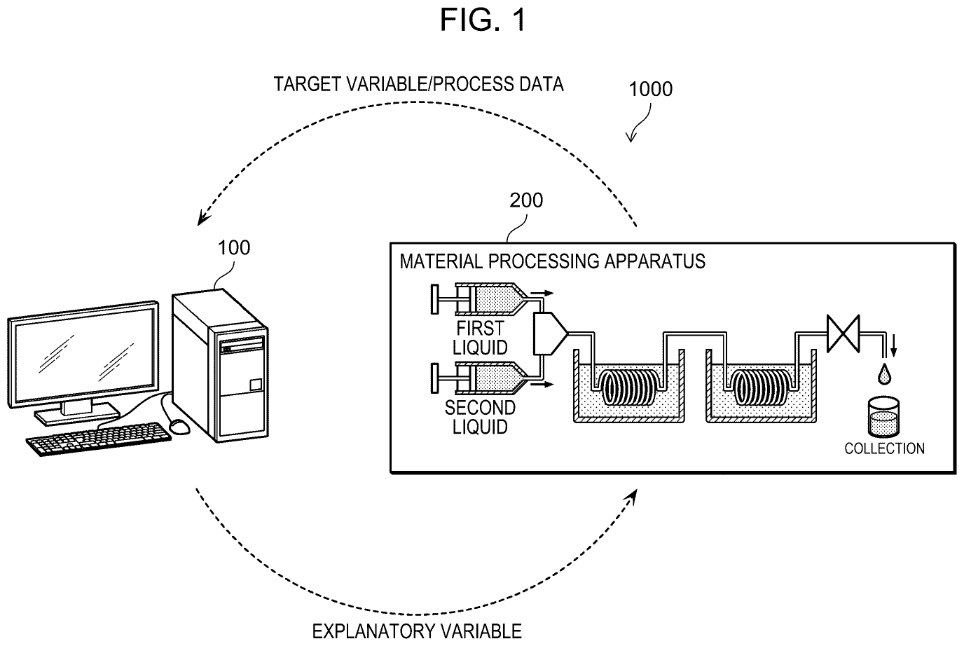

FIG. 1 is a diagram illustrating an example of a search system according to the present exemplary embodiment.

Search system 1000 according to the present exemplary embodiment includes search device 100 and material processing apparatus 200.

Material processing apparatus 200 is an apparatus that generates a product by processing a raw material. For example, material processing apparatus 200 performs flow synthesis by causing a plurality of types of liquid (for example, first liquid and second liquid) as raw materials to flow through a flow path and causing the liquid to sequentially react with each other in the flow path. Further, liquid flowing in the flow path may be heated or cooled. A product is generated by such flow synthesis. Note that material processing apparatus 200 according to the present exemplary embodiment may be referred to as a reactor or a chemical reactor. Further, material processing apparatus 200 according to the present exemplary embodiment is not limited to the example illustrated in FIG. 1, and may be an apparatus having another configuration such as a semiconductor processing apparatus as long as material processing apparatus 200 is an apparatus that performs processing on a raw material.

Search device 100 searches for a processing condition of material processing apparatus 200 for obtaining a target characteristic value (also referred to as physical property value) of a product. That is, search device 100 searches for an optimal solution of a processing condition. Note that a processing condition is expressed as an explanatory variable or an input parameter, and a characteristic value of a product is expressed as a target variable or an output parameter. Such search device 100 inputs or sets an explanatory variable to material processing apparatus 200, and acquires, from material processing apparatus 200, a target variable obtained by processing a raw material according to the explanatory variable. At this time, search device 100 also acquires process data to be described later from material processing apparatus 200 together with the target variable. Then, search device 100 generates a prediction model by using a known explanatory variable, a target variable, and process data, and derives, as an optimal solution, a processing condition for obtaining a target characteristic value, that is, a value of an explanatory variable, by using the prediction model. Note that a value of the explanatory variable (processing condition) is also referred to as a search condition. In a specific example, search device 100 is configured as a personal computer or a server, and is connected to an input device such as a keyboard and a mouse and a display device such as a display.

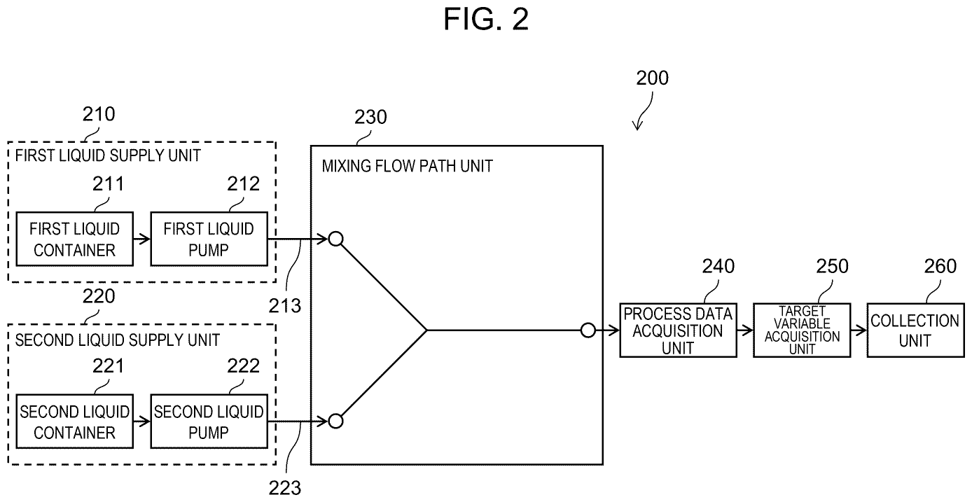

FIG. 2 is a block diagram illustrating an example of a configuration of material processing apparatus 200 according to the present exemplary embodiment.

Material processing apparatus 200 according to the present exemplary embodiment is a reactor that generates mixed liquid as a product by mixing and synthesizing first liquid and second liquid soluble in each other. Material processing apparatus 200 as described above includes first liquid supply unit 210, second liquid supply unit 220, mixing flow path unit 230, process data acquisition unit 240, target variable acquisition unit 250, and collection unit 260. Note that, in FIG. 2, flow of liquid is indicated by a solid arrow.

First liquid supply unit 210 supplies the first liquid to mixing flow path unit 230 via first liquid flow path 213. Specifically, first liquid supply unit 210 includes first liquid container 211 and first liquid pump 212. First liquid container 211 is a container that contains the first liquid. First liquid pump 212 pumps out the first liquid in first liquid container 211 and delivers the first liquid to mixing flow path unit 230 via first liquid flow path 213 under pressure.

Second liquid supply unit 220 supplies the second liquid to mixing flow path unit 230 via second liquid flow path 223. Specifically, second liquid supply unit 220 includes second liquid container 221 and second liquid pump 222. Second liquid container 221 is a container that contains the second liquid. Second liquid pump 222 pumps out the second liquid in second liquid container 221 and delivers the second liquid to mixing flow path unit 230 via second liquid flow path 223 under pressure.

Mixing flow path unit 230 has a mixing flow path for sequentially mixing the first liquid flowing through first liquid flow path 213 and the second liquid flowing through second liquid flow path 223, and allowing the liquid to flow. The first liquid and the second liquid are mixed, so that mixed liquid is generated and flows through the mixing flow path. Note that the mixed liquid is also referred to as a synthetic material, a produced material, or a product. Mixing flow path unit 230 as described above may have a flow path including, for example, a microreactor and a micromixer. In this case, a diameter of the flow path is several micrometers to several millimeters, and it can be said that material processing apparatus 200 is a microflow reactor that performs microflow synthesis.

Process data acquisition unit 240 acquires process data indicating a state of a process for processing a raw material, that is, a state of a mixing process of the first liquid and the second liquid, for example, by measurement using a sensor. Specifically, the process data indicates, for example, pressure of mixed liquid flowing through mixing flow path unit 230. Further, the process data may indicate pressure of the first liquid flowing through first liquid flow path 213 or pressure of the second liquid flowing through second liquid flow path 223. Further, the process data may also indicate a flow rate, a viscosity, a pH, a temperature, or the like of at least one of the first liquid, the second liquid, and mixed liquid, or may indicate other numerical values.

Target variable acquisition unit 250 includes a sensor, and acquires a target variable indicating a characteristic value of a product that is mixed liquid by using the sensor. For example, the characteristic value is particle size, particle size distribution, absorbance, or the like of a product, but is not limited to these, and may be other numerical values. Further, an acquired target variable indicates a value actually measured by the above-described sensor.

Collection unit 260 collects a product that is mixed liquid. Note that target variable acquisition unit 250 may acquire a target variable of a product collected by collection unit 260.

Here, material processing apparatus 200 according to the present exemplary embodiment performs mixing of the first liquid and the second liquid as processing on a raw material according to an explanatory variable input or set by search device 100. The explanatory variable indicates, for example, heating temperature, concentration of a raw material, a flow rate of a raw material, and the like. Note that the explanatory variable is not limited to these, and may indicate other numerical values. The heating temperature is, for example, at least one of a set temperature for first liquid supply unit 210 to heat the first liquid and a set temperature for second liquid supply unit 220 to heat the second liquid. In this case, first liquid supply unit 210 and second liquid supply unit 220 may include a thermostatic bath or the like that allows control of temperature of the first liquid and the second liquid according to an explanatory variable. Alternatively, the heating temperature is, for example, a set temperature for heating mixed liquid. In this case, mixing flow path unit 230 may include a thermostatic bath or the like that allows control of temperature of mixed liquid according to an explanatory variable. Further, the concentration of a raw material is, for example, concentration of at least one of the first liquid and the second liquid. In this case, first liquid supply unit 210 and second liquid supply unit 220 may have a mechanism capable of adjusting the concentration according to an explanatory variable. Further, the flow rate of a raw material is, for example, a flow rate of at least one of the first liquid and the second liquid. In this case, first liquid supply unit 210 and second liquid supply unit 220 may adjust a flow rate of supplied liquid according to an explanatory variable. Further, a mixing ratio of the first liquid and the second liquid may be adjusted by adjustment of concentration or a flow rate of a raw material.

Note that although material processing apparatus 200 illustrated in FIG. 2 mixes two types of liquid, the number of types of liquid to be mixed is not limited to two, and may be three or more. For example, in a case where the number of types is three or more, material processing apparatus 200 includes liquid supply units as many as the number of types. These liquid supply units have the same configuration as first liquid supply unit 210 and second liquid supply unit 220, and supply a type of liquid corresponding to the liquid supply units to mixing flow path unit 230.

Further, a main component of the first liquid and the second liquid according to the present exemplary embodiment is water, but the first liquid and the second liquid only need to be any liquid as long as they are soluble in each other, and may be either water-soluble or water-insoluble. For example, the first liquid and the second liquid may be water or an aqueous solution, or may be an organic solvent or oil-based liquid.

Further, process data acquisition unit 240 may be connected to first liquid supply unit 210, second liquid supply unit 220, or collection unit 260, and may acquire two or more pieces of process data.

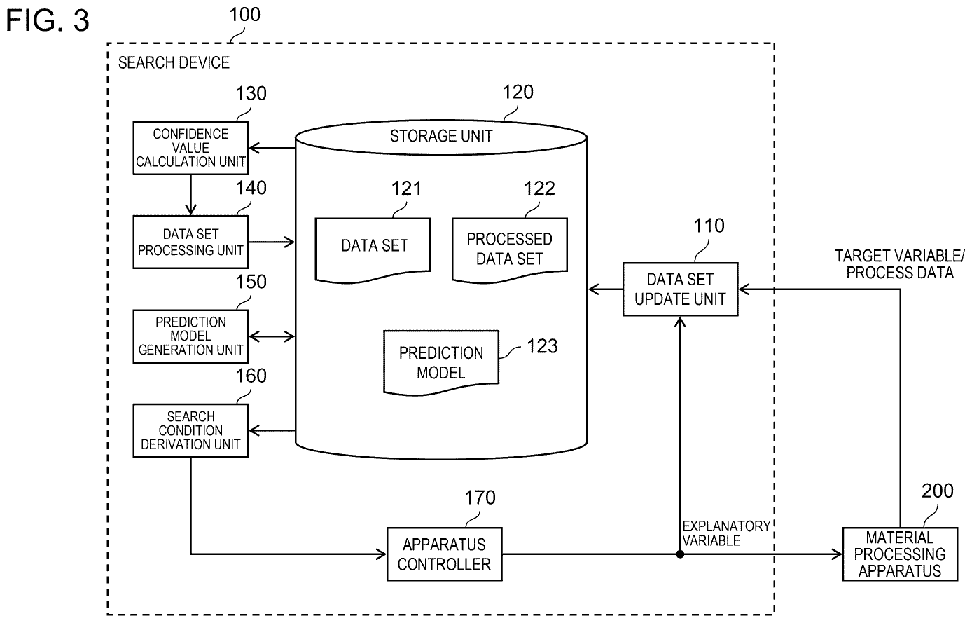

FIG. 3 is a block diagram illustrating an example of a configuration of search device 100 according to the present exemplary embodiment.

Search device 100 includes data set update unit 110, storage unit 120, confidence value calculation unit 130, data set processing unit 140, prediction model generation unit 150, search condition derivation unit 160, and apparatus controller 170.

Data set update unit 110 acquires an explanatory variable from apparatus controller 170, and acquires a target variable and process data obtained by mixing according to the explanatory variable from material processing apparatus 200. That is, data set update unit 110 acquires a combination including a value indicated by an explanatory variable, a value indicated by a target variable, and process data. The value indicated by an explanatory variable is also referred to as a value of an explanatory variable, and the value indicated by a target variable is also referred to as a value of a target variable. Then, data set update unit 110 generates or updates data set 121 including the combination. That is, if data set 121 is not stored in storage unit 120, data set update unit 110 generates data set 121 including the combination and stores the data set 121 in storage unit 120. On the other hand, if data set 121 is already stored in storage unit 120, data set update unit 110 updates data set 121 stored in storage unit 120 by reading existing data set 121 from storage unit 120 and including an acquired combination in existing data set 121. Such data set 121 indicates an explanatory variable, a target variable, and process data in association with each other by including one or more of the above-described combinations. Note that, in the present exemplary embodiment, process data is included in data set 121, but may be stored in storage unit 120 without being included in data set 121.

As described above, data set update unit 110 according to the present exemplary embodiment generates or updates data set 121 indicating a target variable indicating a characteristic value of a product obtained by processing on a raw material according to an explanatory variable by material processing apparatus 200 and the explanatory variable in association with each other.

Storage unit 120 is a recording medium for storing data set 121 and the like. Storage unit 120 according to the present exemplary embodiment has storage capacity for storing not only data set 121 but also processed data set 122 and prediction model 123. For example, storage unit 120 is a hard disk drive, a Random Access Memory (RAM), a Read Only Memory (ROM), a semiconductor memory, or the like. Note that storage unit 120 may be volatile or non-volatile.

Confidence value calculation unit 130 reads data set 121 from storage unit 120, and calculates, for each combination included in data set 121, a confidence value with respect to a value of a target variable included in the combination based on process data included in the combination. Then, confidence value calculation unit 130 outputs a confidence value calculated for each combination to data set processing unit 140. As described above, confidence value calculation unit 130 according to the present exemplary embodiment calculates a confidence value of the target variable based on process data indicating a state of a process for processing a raw material obtained from material processing apparatus 200.

Data set processing unit 140 acquires a confidence value for each combination from confidence value calculation unit 130, and processes data set 121 based on confidence values of the combinations. Data set processing unit 140 generates processed data set 122 by the processing, and stores generated processed data set 122 in storage unit 120.

Prediction model generation unit 150 reads processed data set 122, which is data set 121 that is processed, from storage unit 120, and uses processed data set 122 to generate prediction model 123 indicating a relationship between an explanatory variable and a target variable. Prediction model 123 is, for example, a model generated by machine learning so as to output, with respect to input of a value of a target variable, a value of an explanatory variable for obtaining the value. That is, prediction model generation unit 150 generates prediction model 123 by machine learning using processed data set 122. Prediction model 123 is, for example, a neural network. Prediction model generation unit 150 stores generated prediction model 123 in storage unit 120.

Search condition derivation unit 160 reads prediction model 123 from storage unit 120 and performs a search using prediction model 123 to derive, as a search condition, a value of an explanatory variable for obtaining a target value of a target variable. Then, search condition derivation unit 160 outputs the value of the explanatory variable, which is the derived search condition, to apparatus controller 170. Note that the search condition is used as a condition of processing by material processing apparatus 200, that is, the above-described processing condition.

Apparatus controller 170 controls material processing apparatus 200. Specifically, when acquiring a value of an explanatory variable as a processing condition from search condition derivation unit 160, apparatus controller 170 outputs the value of the explanatory variable to material processing apparatus 200 and causes material processing apparatus 200 to perform mixing according to the explanatory variable. Note that the value of the explanatory variable that is a processing condition is also output from apparatus controller 170 to data set update unit 110. By the above, material processing apparatus 200 outputs a new value of a target variable obtained according to the derived value of the explanatory variable and new process data indicating a state of the mixing process to data set update unit 110.

Data set update unit 110 determines whether or not the new value of the target variable reaches a target value, and in a case of determining that the new value of the target variable does not reach the target value, data set update unit 110 executes update of data set 121 using the new value of the target variable in the same manner as described above. On the other hand, in a case of determining that the new value of the target variable reaches the target value, data set update unit 110 ends the processing of a search for an explanatory variable. That is, as a result of a search, a value of an explanatory variable derived immediately before is determined as an optimal solution.

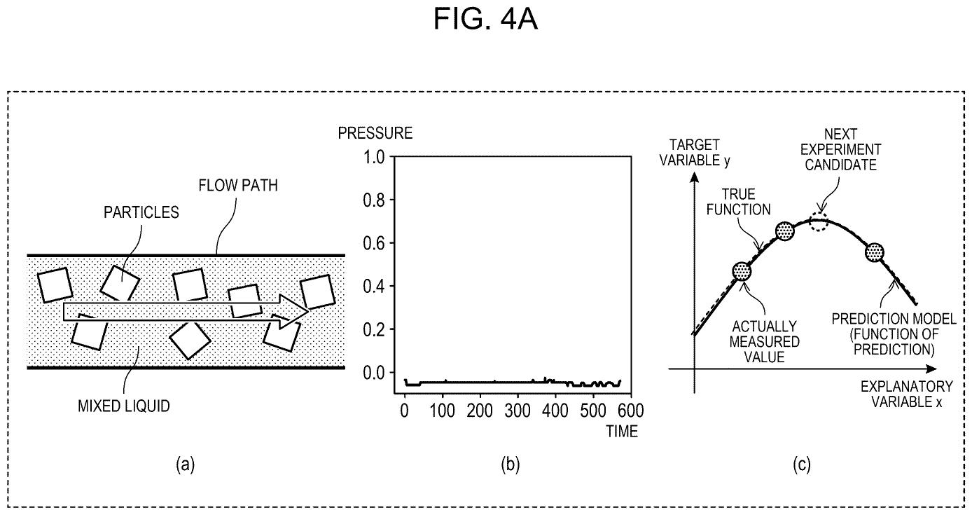

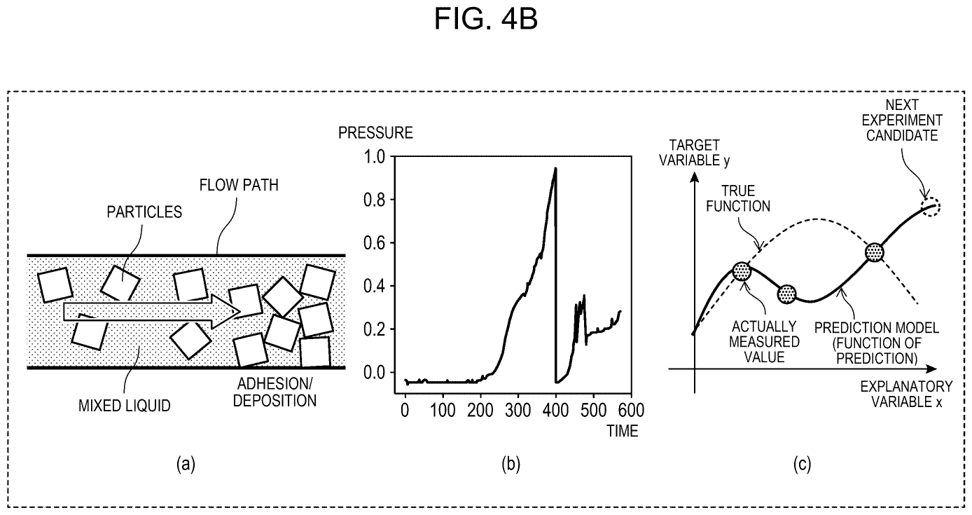

Here, in a case where a prediction model is generated from an explanatory variable and a target variable indicated in data set 121 instead of processed data set 122, there is a possibility that an inappropriate search for an explanatory variable is performed by the prediction model. For example, in the following example of FIG. 4A, an appropriate search is performed, but in an example of FIG. 4B, an inappropriate search is performed.

FIG. 4A is a diagram for describing a relationship between process data and a prediction model. Specifically, FIG. 4A is a diagram for describing the above-described relationship when processing on a raw material by material processing apparatus 200 is stable.

For example, mixed liquid smoothly flows in a flow path as illustrated in part (a) of FIG. 4A. That is, even if particles are contained in mixed liquid, the particles flow without being deposited or adhering to an inner surface of a flow path. Note that the flow path is, for example, a flow path from mixing flow path unit 230 to target variable acquisition unit 250 in material processing apparatus 200.

In such a case, data set update unit 110 acquires, for example, process data illustrated in part (b) of FIG. 4A from process data acquisition unit 240 of material processing apparatus 200. This process data indicates, for example, pressure of mixed liquid flowing through a flow path. Note that in the graph illustrated in part (b) of FIG. 4A, the horizontal axis represents time, and the vertical axis represents pressure. In the process data illustrated in part (b) of FIG. 4A, pressure is stable without greatly fluctuating. That is, processing of mixing the first liquid and the second liquid by material processing apparatus 200 is stable.

Here, when mixing by material processing apparatus 200 is performed under a plurality of processing conditions, in a case where process data (that is, pressure) is stable as illustrated in part (b) of FIG. 4A, a value of a target variable with high reliability for these processing conditions is obtained by material processing apparatus 200. Therefore, by using explanatory variable x as the processing condition and target variable y obtained by explanatory variable x, it is possible to generate a prediction model sufficiently close to a true function as illustrated in part (c) of FIG. 4A.

Note that the horizontal axis of the graph illustrated in part (c) of FIG. 4A indicates explanatory variable x, and the vertical axis indicates target variable y. Further, a solid line in part (c) of FIG. 4A indicates a prediction model (that is, a predicted function) generated from a plurality of actually measured values. The actually measured value is a set of a value of explanatory variable x used in processing of material processing apparatus 200 and a value of target variable y that is an actually measured characteristic value of mixed liquid generated by processing using a value of explanatory variable x. Further, a broken line in part (c) of FIG. 4A indicates a true relationship between explanatory variable x and target variable y, that is, a true function.

Therefore, by using such a prediction model, a value of explanatory variable x for obtaining a target value (for example, a maximum value) of target variable y can be appropriately derived as a next experiment candidate (that is, search condition).

FIG. 4B is a diagram for describing another relationship between process data and a prediction model. Specifically, FIG. 4B is a diagram for describing the above-described relationship when processing on a raw material of material processing apparatus 200 is unstable.

For example, mixed liquid does not smoothly flow in a flow path as illustrated in part (a) of FIG. 4B. Specifically, particles contained in mixed liquid repeatedly flow and remain in a flow path. When the particles remain, the particles are deposited in a flow path or attached to an inner surface of a flow path.

In such a case, data set update unit 110 acquires, for example, process data illustrated in part (b) of FIG. 4B from process data acquisition unit 240 of material processing apparatus 200. This process data also indicates pressure of mixed liquid flowing through a flow path, as in the example of FIG. 4A. Note that in the graph illustrated in part (b) of FIG. 4B, the horizontal axis represents time, and the vertical axis represents pressure. In process data illustrated in part (b) of FIG. 4B, pressure greatly fluctuates. That is, processing of mixing the first liquid and the second liquid by material processing apparatus 200 is unstable.

Here, in a case where process data (that is, pressure) is unstable as illustrated in part (b) of FIG. 4B when mixing by material processing apparatus 200 is performed under a plurality of processing conditions, a value of a target variable with low reliability for those processing conditions is obtained by material processing apparatus 200. Therefore, when explanatory variable x as the processing condition and target variable y obtained by explanatory variable x are used, there is a possibility that a prediction model far from a true function or a prediction model significantly different from a true function is generated as illustrated in part (c) of FIG. 4B.

Note that the horizontal axis of the graph illustrated in part (c) of FIG. 4B indicates explanatory variable x, and the vertical axis indicates target variable y. Further, a solid line in part (c) of FIG. 4B indicates a prediction model (that is, a predicted function) generated from a plurality of actually measured values. The actually measured value is a set of a value of explanatory variable x used in processing of material processing apparatus 200 and a value of target variable y that is an actually measured characteristic value of mixed liquid generated by processing using a value of explanatory variable x. Further, a broken line in part (c) of FIG. 4B indicates a true relationship between explanatory variable x and target variable y, that is, a true function.

Therefore, in a case where a value of explanatory variable x is derived as a next experiment candidate (that is, search condition) by using such a prediction model in order to obtain a target value (for example, maximum value) of target variable y, there is a possibility that target variable y indicating a value significantly different from the target value is obtained. That is, there is a possibility that an efficient search for explanatory variable x cannot be performed.

In view of the above, in the present exemplary embodiment, data set processing unit 140 generates processed data set 122 by processing data set 121 by using a confidence value. Then, prediction model generation unit 150 generates prediction model 123 by using processed data set 122 instead of data set 121.

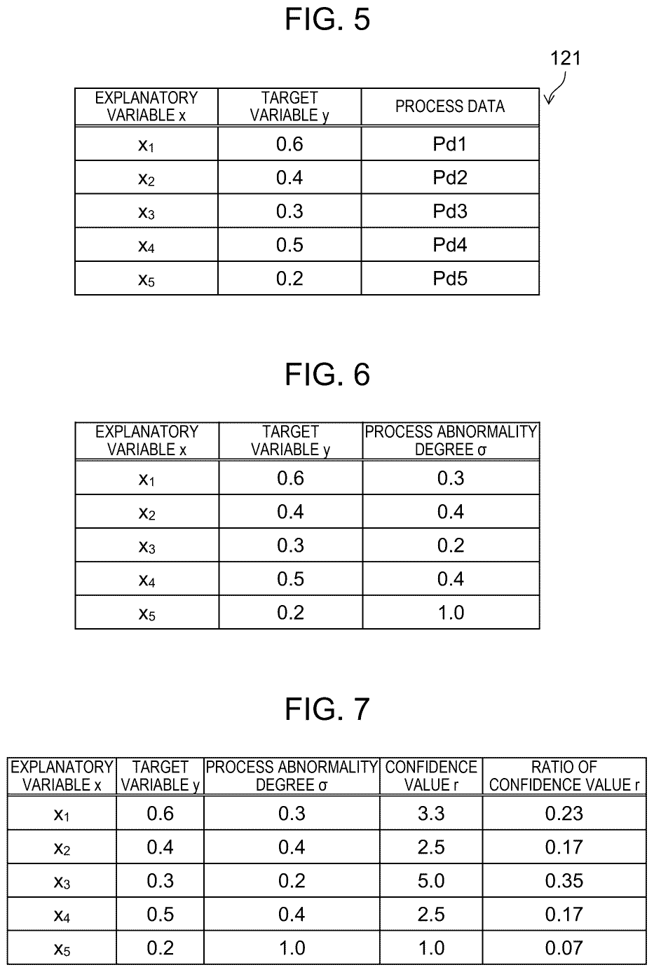

FIG. 5 is a diagram illustrating an example of data set 121.

As illustrated in FIG. 5, data set 121 indicates a value of explanatory variable x, a value of target variable y, and process data in association with each other. That is, data set 121 includes a plurality of combinations, and each of the combinations includes a value of explanatory variable x, a value of target variable y, and process data. A value of explanatory variable x and a value of target variable y included in these combinations correspond to the above-described actually measured values. For example, data set 121 includes a combination including explanatory variable x=x₁, target variable y=0.6, and process data “Pd1”, and includes a combination including explanatory variable x=x₂, target variable y=0.4, and process data “Pd2”. Note that these combinations include values of one type of explanatory variable x and one type of target variable y, but the number of types of explanatory variable x and target variable y included in the combination may be two or more. Further, x₁ to x₅ are values of explanatory variable x.

FIG. 6 is a diagram illustrating an example of process abnormality degree.

For example, as illustrated in FIG. 6, confidence value calculation unit 130 calculates, for each combination included in data set 121, process abnormality degree σ that is abnormality degree of a value of target variable y included in the combination by using process data included in the combination. Process abnormality degree σ indicates a larger value as fluctuation of process data is larger, that is, as process data is more unstable. In a specific example, confidence value calculation unit 130 calculates standard deviation of the process data as process abnormality degree σ. Alternatively, confidence value calculation unit 130 may calculate a difference between a maximum value and a minimum value of process data as process abnormality degree σ, or may calculate a fluctuation coefficient that is a ratio between the standard deviation and an average as process abnormality degree σ. Alternatively, confidence value calculation unit 130 may calculate, as process abnormality degree σ, a value indicated by a combination of at least two of the standard deviation, the difference, and the fluctuation coefficient described above. Further, confidence value calculation unit 130 may calculate process abnormality degree σ by machine learning such as a k-nearest neighbor method or a local outlier factor method.

FIG. 7 is a diagram illustrating an example of a confidence value and a ratio of a confidence value.

When calculating process abnormality degree σ for each of the above-described combinations, confidence value calculation unit 130 calculates confidence value r of a value of target variable y corresponding to process abnormality degree σ based on process abnormality degree σ as illustrated in FIG. 7. For example, confidence value calculation unit 130 calculates the reciprocal of process abnormality degree σ as confidence value r.

Next, when acquiring confidence value r calculated by confidence value calculation unit 130 for each of all values of target variable y, data set processing unit 140 calculates a ratio of confidence value r to a total confidence value. That is, data set processing unit 140 calculates an integrated value by integrating all confidence values r, and divides confidence value r by the integrated value, so as to calculate a ratio of confidence value r. For example, confidence value calculation unit 130 calculates confidence values r=3.3, 2.5, 5.0, 2.5, and 1.0 for five values of target variable y. In this case, since confidence value r of target variable y=0.6 is 3.3, data set processing unit 140 calculates a ratio of confidence value r with respect to target variable y=0.6 as 3.3/(3.3+2.5+5.0+2.5+1.0)=0.23. Similarly, data set processing unit 140 calculates ratios “0.17, 0.35, 0.17, 0.07” of confidence value r with respect to target variables y=0.4, 0.3, 0.5, and 0.2.

Data set processing unit 140 performs weighting of the number of combinations included in data set 121 by using a ratio of confidence value r calculated as described above. That is, data set processing unit 140 processes data set 121 by weighting a training amount according to confidence value r, the training amount being the number of combinations of a value of explanatory variable x and a value of target variable y.

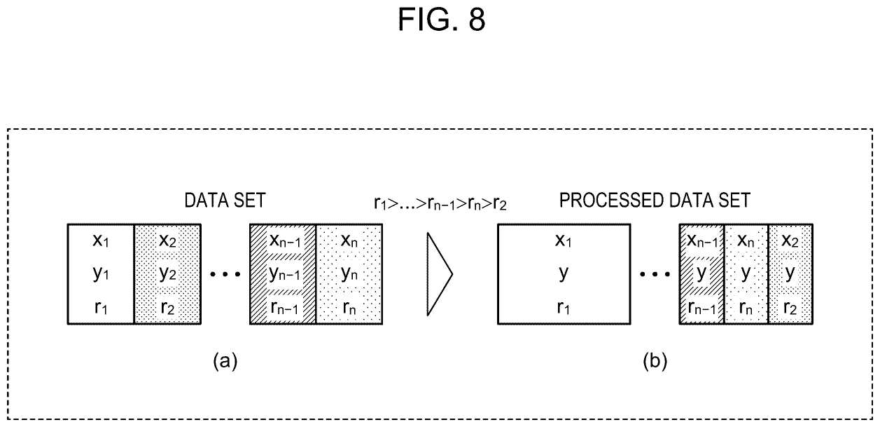

FIG. 8 is a diagram for describing weighting of a training amount.

For example, as illustrated in part (a) of FIG. 8, data set 121 includes combinations of first to n-th (n is, for example, an integer of 4 or more), that is, n combinations. Note that these combinations are combinations that are existing (also referred to as existing combinations). For example, the first combination includes explanatory variable x=x₁ and target variable y=y₁, and confidence value r of target variable y=y₁ is calculated as r₁. Similarly, the second combination includes explanatory variable x=x₂ and target variable y=y₂, and confidence value r of target variable y=y₂ is calculated as r₂. Here, it is assumed that r₁, r₂, . . . , and rₙ, which are n confidence values r, have a relationship of r₁> . . . >rₙ₋₁>rₙ>r₂. Data set processing unit 140 generates processed data set 122 as illustrated in part (b) of FIG. 8 by increasing the number of additional combinations obtained from an existing combination as the existing combination has larger confidence value r. Specifically, data set processing unit 140 increases the number of additional combinations as an existing combination has a higher ratio of confidence value r. Note that horizontal width of a block corresponding to each of n existing combinations illustrated in part (b) of FIG. 8 indicates a ratio of the number of additional combinations obtained from the existing combination. That is, the number of additional combinations corresponding to confidence value r=r₁ is larger than the number of additional combinations corresponding to any other confidence values r, and the number of additional combinations corresponding to confidence value r=r₂ is smaller than the number of combinations corresponding to any other confidence values r. Note that an additional combination obtained from an existing combination includes the same value of explanatory variable x as the existing combination. Further, an additional combination is also referred to as a new combination.

As described above, in the present exemplary embodiment, confidence value calculation unit 130 calculates, for each existing combination that is a combination included in data set 121, confidence value r of a value of target variable y based on process data when a value of target variable y included in the existing combination is obtained. Then, data set processing unit 140 performs weighting of the above-described training amount by changing the number of combinations including a value of explanatory variable x corresponding to confidence value r according to confidence value r for each confidence value r. Specifically, confidence value calculation unit 130 calculates confidence value r indicating a smaller value as variation of a value indicated by process data is greater. Then, data set processing unit 140 changes the number of combinations by increasing the number of the combinations as confidence value r is larger.

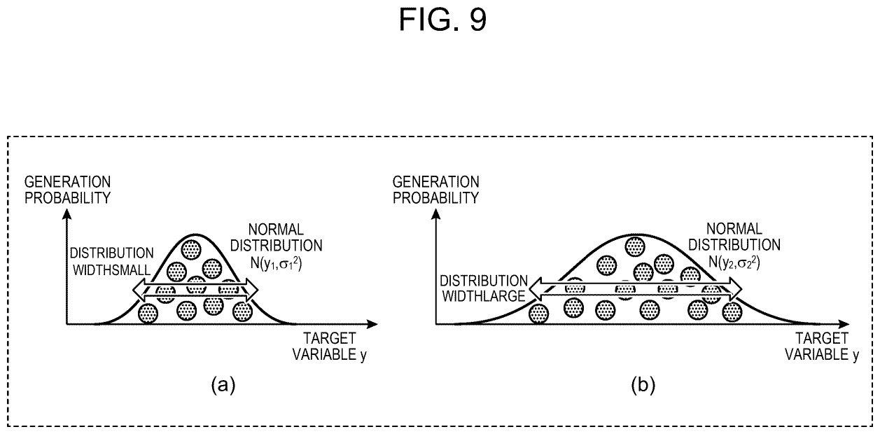

FIG. 9 is a diagram for describing target variable y included in an additional combination.

Data set processing unit 140 generates one or more additional combinations from an existing combination. At this time, data set processing unit 140 uses probability distribution having the square of process abnormality degree σ corresponding to the existing combination as variance 62 and having a value of target variable y included in the existing combination as an average. This probability distribution is, for example, normal distribution.

In a specific example, an existing combination includes explanatory variable x=x₁ and target variable y=y₁, and process abnormality degree σ corresponding to the existing combination is σ₁. Therefore, data set processing unit 140 uses normal distribution expressed by N(y₁, σ₁²) illustrated in part (a) of FIG. 9 for the existing combination. The normal distribution expressed as described above has average y₁ and variance σ₁². Then, according to the normal distribution, data set processing unit 140 randomly selects values of target variable y included in an additional combination as many as the number corresponding to a ratio of confidence value r=r₁ calculated for target variable y=y₁. Note that each of these additional combinations includes explanatory variable x=x₁.

Further, another existing combination includes explanatory variable x=x₂ and target variable y=y₂, and process abnormality degree σ corresponding to the existing combination is σ₂. Therefore, data set processing unit 140 uses normal distribution expressed by N(y₂, σ₂²) illustrated in part (b) of FIG. 9 for the existing combination. The normal distribution expressed as described above has average y₂ and variance 22. Then, according to the normal distribution, data set processing unit 140 randomly selects values of target variable y included in an additional combination as many as the number corresponding to a ratio of confidence value r=r₂ calculated for target variable y=y₂. Note that each of these additional combinations includes explanatory variable x=x₂.

As described above, in the present exemplary embodiment, data set processing unit 140 selects a new value of target variable y included in each of a plurality of new combinations according to probability distribution having a value of target variable y included in an existing combination as an average. Specifically, data set processing unit 140 uses normal distribution as the probability distribution, and randomly selects a new value of target variable y according to the normal distribution. That is, when generating a plurality of new combinations from an existing combination by increasing the number of combinations, data set processing unit 140 includes, instead of a value of target variable y included in the existing combination, a value different from the value of target variable y as a new value of target variable y in each of at least one of a plurality of the new combinations.

Here, in the example of part (a) of FIG. 9, since confidence value r=r₁ is large, variance σ₁² is small. Therefore, distribution width of normal distribution is small. For this reason, data set processing unit 140 generates many additional combinations each including a value relatively close to average y₁ (that is, a value similar to average y₁) as a value of target variable y according to the normal distribution. Note that, in an additional combination, the same value as a value of target variable y (that is, average y₁) included in an existing combination may be included as a new value of target variable y.

On the other hand, in the example of part (b) of FIG. 9, since confidence value r=r₂ is small, variance σ₂² is large. Therefore, distribution width of normal distribution is large. Therefore, data set processing unit 140 may generate an additional combination including a value relatively far from average y₂ (that is, a value not similar to average y₂) as a value of target variable y according to the normal distribution. Note that, in an additional combination, the same value as a value of target variable y (that is, average y₂) included in an existing combination may be included as a new value of target variable y. Further, data set processing unit 140 generates such additional combinations as many as the number smaller than the example of part (a) of FIG. 9.

As described above, in the present exemplary embodiment, data set processing unit 140 uses normal distribution having a smaller variance as confidence value r is larger.

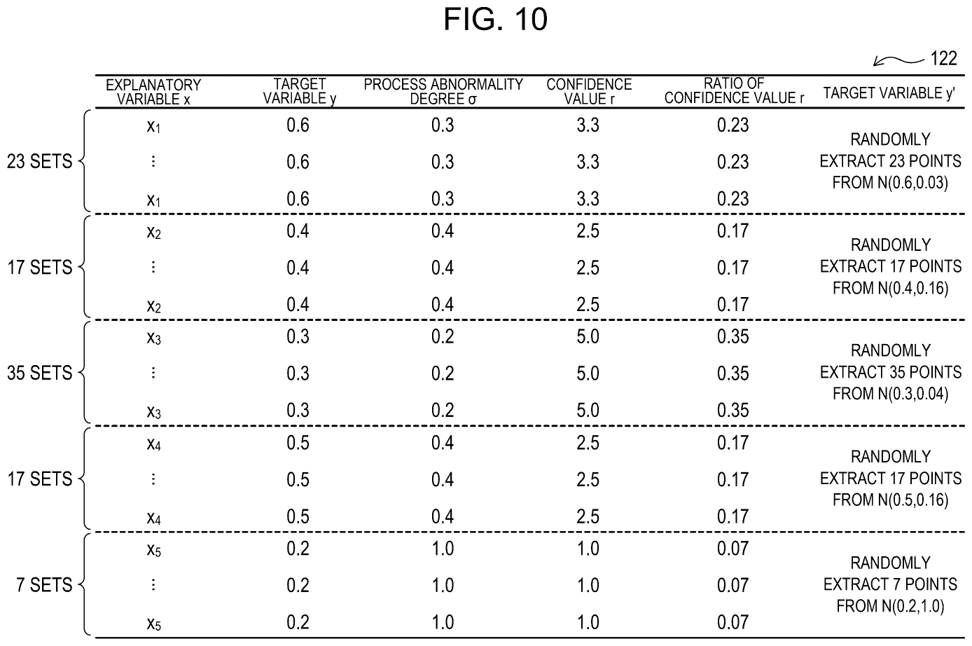

FIG. 10 is a diagram illustrating an example of processed data set 122.

For example, as illustrated in FIG. 10, processed data set 122 includes 23 additional combinations each including explanatory variable x=x₁, 17 additional combinations each including explanatory variable x=x₂, 35 additional combinations each including explanatory variable x=x₃, 17 additional combinations each including explanatory variable x=x₄, and 7 additional combinations each including explanatory variable x=x₅.

That is, data set processing unit 140 generates 23 additional combinations each including explanatory variable x=x₁ from an existing combination including explanatory variable x=x₁ and target variable y=0.6. At this time, since a ratio of confidence value r corresponding to the existing combination is 0.23, data set processing unit 140 determines the number of additional combinations generated from the existing combination as 0.23×100=23. That is, data set processing unit 140 calculates a numerical value 100 times the ratio of confidence value r as the number of additional combinations. Then, data set processing unit 140 selects (or extracts) 23 values of target variable y′ according to normal distribution expressed by N(y₁, σ₁²)=N (0.6, 0.03). Note that a value of target variable y′ is a value of target variable y included in an additional combination. By the above, 23 additional combinations are generated. Similarly, data set processing unit 140 generates 17 additional combinations each including explanatory variable x=x₂ from an existing combination including explanatory variable x=x₂ and target variable y=0.4. At this time, since a ratio of confidence value r corresponding to the existing combination is 0.17, data set processing unit 140 determines the number of additional combinations generated from the existing combination as 0.17×100=17. Then, data set processing unit 140 selects (or extracts) 17 values of target variable y′ according to normal distribution expressed by N(y₂, σ₂²)=N (0.4, 0.16). By the above, 17 additional combinations are generated.

Here, a ratio of confidence value r corresponding to an existing combination including explanatory variable x=x₃ is the largest, and a ratio of confidence value r corresponding to an existing combination including explanatory variable x=x₅ is the smallest. Therefore, a largest number of additional combinations are generated from an existing combination including explanatory variable x=x₃, and a value of target variable y′ included in the additional combinations is relatively close to a value of target variable y included in the existing combination. On the other hand, a smallest number of additional combinations are generated from an existing combination including explanatory variable x=x₅, and a value of target variable y′ included in the additional combinations includes a value relatively far from a value of target variable y included in the existing combination.

As described above, in the present exemplary embodiment, data set processing unit 140 generates, from an existing combination included in data set 121, additional combinations as many as the number corresponding to confidence value r of the existing combination. That is, data set processing unit 140 generates a larger number of additional combinations as confidence value r is larger. In other words, by performing weighting according to confidence value r on the number of existing combinations included in data set 121, data set processing unit 140 generates a larger number of additional combinations than existing combinations. Therefore, the number of combinations is increased. Since many additional combinations are generated from an existing combination having a large confidence value r, a training amount of machine learning by prediction model generation unit 150 based on the existing combination can be increased. On the other hand, since a small number of additional combinations are generated from an existing combination having small confidence value r, it is possible to suppress overfitting in machine learning by prediction model generation unit 150 based on the existing combination.

Note that, in the above example, the number of additional combinations is determined by multiplying a ratio of confidence value r by 100, but a ratio of confidence value r may be multiplied by a value larger than 100. By the above, a larger number of additional combinations are generated, and the above-described overfitting can be further suppressed. Further, the number of additional combinations may be determined by multiplying a ratio of confidence value r by a value smaller than 100. In this case, since the number of additional combinations can be suppressed as compared with the case of multiplication by 100, a processing load of search device 100 can be reduced. Further, time required for a search by search device 100 can be reduced.

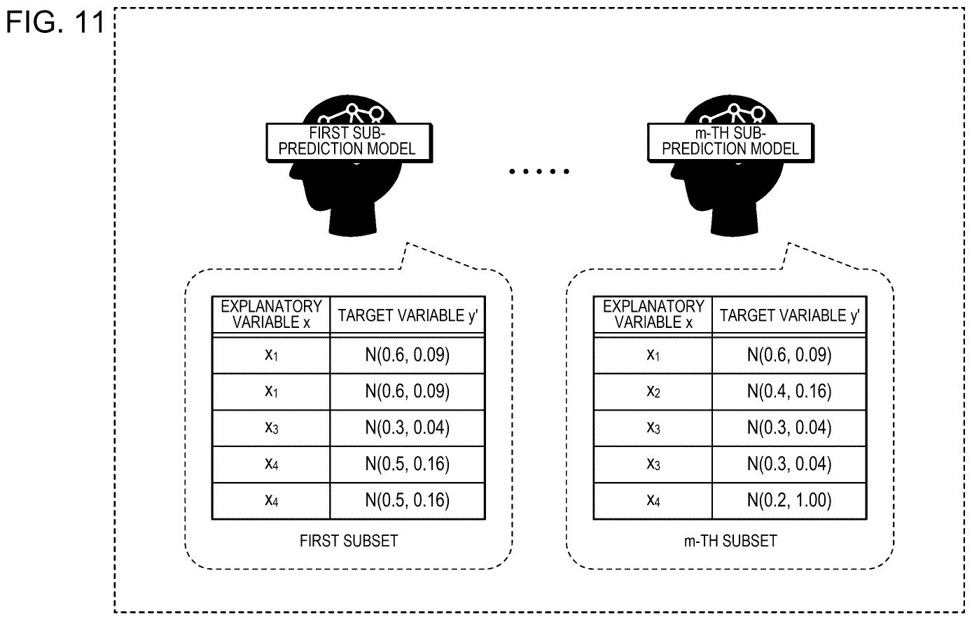

FIG. 11 is a diagram for describing an example of processing by prediction model generation unit 150.

Prediction model generation unit 150 divides processed data set 122 into, for example, m (m is an integer of 2 or more) subsets in order to generate prediction model 123 by ensemble learning. Then, prediction model generation unit 150 generates, for each of the subsets, a sub-prediction model that is a prediction model corresponding to the subset. For example, each of 23 additional combinations including explanatory variable x=x₁ is classified into any one subset among a first subset to an m-th subset, and each of 17 additional combinations including explanatory variable x=x₂ is classified into any one subset among the first subset to the m-th subset. Then, prediction model generation unit 150 generates a first sub-prediction model corresponding to the first subset from the first subset, and generates a second sub-prediction model corresponding to the second subset from the second subset. For the other subsets, similarly, sub-prediction models corresponding to the subsets are generated. By the above, m sub-prediction models, that is, the first sub-prediction model to the m-th sub-prediction model are generated. Note that a sub-prediction model indicates a relationship between explanatory variable x and target variable y included in a subset corresponding to the sub-prediction model. Further, prediction model generation unit 150 generates such a sub-prediction model by using machine learning. A specific method of the machine learning is, for example, a support vector machine, a neural network, a random forest, or the like. Note that machine learning in which two or more methods are combined without limitation to one method may be performed.

Next, prediction model generation unit 150 generates prediction model 123 by integrating the first sub-prediction model to the m-th sub-prediction model.

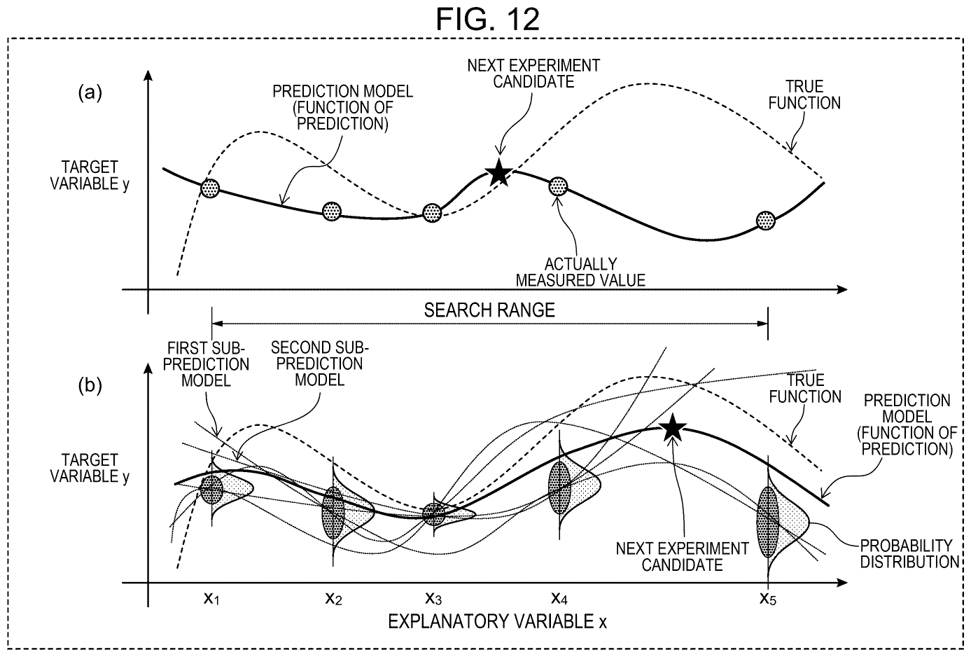

FIG. 12 is a diagram for describing a search using prediction model 123. Note that the horizontal axis of each graph in part (a) and part (b) of FIG. 12 represents explanatory variable x, and the vertical axis represents target variable y. Further, part (a) of FIG. 12 illustrates a comparative example of a search, and part (b) of FIG. 12 illustrates an example of a search using prediction model 123.

For example, by mixing performed by material processing apparatus 200 using processing conditions of explanatory variables x=x₁, x₂, x₃, x₄, and x₅, five values of target variable y indicating a characteristic value of mixed liquid are obtained. That is, (x, y)=(x₁, y₁), (x₂, y₂), (x₃, y₃), (x₄, y₄), and (x₅, y₅) are obtained as actually measured values. Then, in the example of part (a) of FIG. 12, a prediction model is generated from these actually measured values. Here, as in the examples of FIGS. 4A and 4B, in a case where process data is unstable, the prediction model indicates a function significantly different from a true function. That is, in machine learning for generating the prediction model, weights equal to each other are used for both a combination having large confidence value r and a combination having small confidence value r. Therefore, in a case where a target value of target variable y is, for example, a maximum value and a search range of explanatory variable x is x=x₁ to x₅, a value of explanatory variable x, which is an erroneous search condition different from an optimal solution, is derived from the prediction model illustrated in part (a) of FIG. 12. That is, in the example of part (a) of FIG. 12, since confidence value r is not considered, it is difficult to derive an appropriate search condition. Note that the example of part (a) of FIG. 12 can also be said to be an example of a conventional search.

On the other hand, in the present exemplary embodiment, as illustrated in part (b) of FIG. 12, a value of explanatory variable x serving as a search condition can be appropriately derived. That is, for example, in the case of m=5, prediction model generation unit 150 generates prediction model 123 by generating five sub-prediction models and integrating the five sub-prediction models. Prediction model 123 is a prediction model generated based on processed data set 122, that is, based on confidence value r. In generation of processed data set 122, additional combinations as many as the number corresponding to confidence value r are generated from an existing combination including explanatory variable x=x₁ and target variable y=y₁ by using probability distribution (specifically, normal distribution) based on confidence value r of target variable y=y₁. Similarly, from an existing combination including explanatory variable x=x₂ and target variable y=y₂, additional combinations as many as the number according to confidence value r are generated by using probability distribution (specifically, normal distribution) based on confidence value r of target variable y=y₂. By weighting such an existing combination, a plurality of additional combinations are generated. That is, a combination having a large confidence value r is given a larger weight than a combination having a small confidence value r. Then, prediction model 123 is generated by machine learning using additional combinations generated by such weighting.

Therefore, even if process data is unstable, prediction model 123 shows a function close to a true function as compared with the prediction model as in the example of part (a) of FIG. 12. Therefore, in a case where a target value of target variable y is, for example, a maximum value and a search range of explanatory variable x is x=x₁ to x₅, search condition derivation unit 160 can derive an appropriate value of explanatory variable x close to an optimal solution as a search condition by using prediction model 123.

As described above, in the present exemplary embodiment, a value of target variable y is processed into a value of target variable y′ by using a random number according to normal distribution N(y, σ²). By the above, at the time of generation of prediction model 123, a value different from a value of target variable y can be used for machine learning, and more flexible prediction model 123 can be generated. Further, by using a random number according to normal distribution N(y, σ²), as a value of target variable y has higher process abnormality degree σ, a value of target variable y′ having a larger difference from the value may be included in an additional combination and used for machine learning. Therefore, it is possible to suppress overfitting with respect to a value of target variable y having small confidence value r.

Note that in the above example, the square of process abnormality degree σ (that is, σ²) is used as variance of normal distribution used for selection of a value of target variable y′, but the variance is not limited to this, and may be another value. For example, in a case where magnitude of influence of process abnormality (that is, process abnormality degree σ) on target variable y is known in advance, σ² weighted according to the magnitude of the influence may be used for variance of normal distribution described above.

Further, in the above example, a random number according to normal distribution N(y, σ²) is used for selection of a value of target variable y′, but a random number in a range of y±σ may be used. In this case, a value smaller than y−σ and a value larger than y+σ are not selected as a value of target variable y′. Further, in the above example, normal distribution is used, but other probability distribution may be used instead of normal distribution.

Note that overfitting according to the present exemplary embodiment is, for example, training that generates a prediction model in which prediction is performed with high accuracy for data used for the training, but prediction cannot be performed with similar accuracy for unknown data, and search efficiency is lowered. In the above-described example, ensemble learning is used for processed data set 122, so that the overfitting can be suppressed. Note that ensemble learning does not need to be used to generate a prediction model.

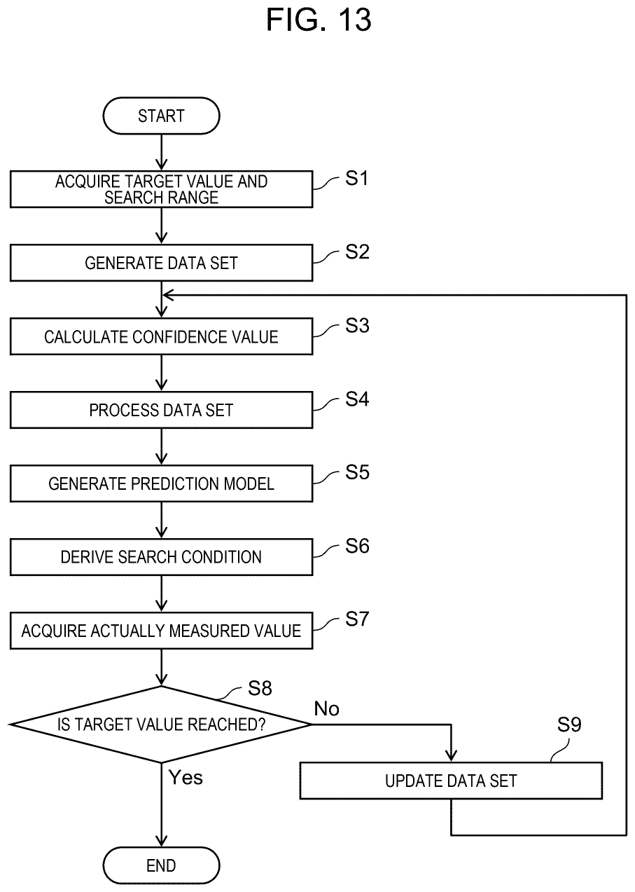

FIG. 13 is a flowchart illustrating an example of processing operation of search device 100 according to the present exemplary embodiment. Note that, in the example illustrated in FIG. 13, the number of types of each of explanatory variable x and target variable y is one, but may be two or more.

First, search condition derivation unit 160 of search device 100 acquires a target value of target variable y and a search range of explanatory variable x (step S1). For example, search condition derivation unit 160 may acquire a target value and a search range according to an input operation on an input device such as a keyboard, and when a target value and a search range are stored in storage unit 120, these may be read and acquired from storage unit 120. Alternatively, when search device 100 includes a communication interface, search condition derivation unit 160 may acquire a target value and a search range from the outside of search device 100 via the communication interface.

Next, data set update unit 110 acquires explanatory variable x from apparatus controller 170 by an initial experiment by material processing apparatus 200, and acquires target variable y and process data obtained by mixing according to explanatory variable x from material processing apparatus 200. That is, data set update unit 110 acquires a combination including a value of explanatory variable x and a value of target variable y. Then, data set update unit 110 generates data set 121 including the combination and stores data set 121 in storage unit 120 (step S2). Note that the processing in step S2 may be performed before the processing in step S1, or may be performed simultaneously with the processing in step S1.

Note that in an initial experiment, apparatus controller 170 may randomly select a value of explanatory variable x from the search range acquired in step S1 and set the value in material processing apparatus 200. Alternatively, apparatus controller 170 may select a value of explanatory variable x by using a statistical method such as design of experiments. Further, in step S2, data set update unit 110 may acquire two or more of the above-described combinations and generate data set 121 including these combinations. The number of the combinations is not particularly limited, and may be one or two. However, as the number of the combinations is larger, prediction accuracy by prediction model 123 generated from data set 121 is improved more.

Next, confidence value calculation unit 130 calculates, for each combination indicated in data set 121, that is, for each existing combination, confidence value r of a value of target variable y included in the existing combination (step S3). Then, data set processing unit 140 generates processed data set 122 by processing data set 121 by using confidence value r calculated in step S3 (step S4).

Next, prediction model generation unit 150 generates prediction model 123 by machine learning using processed data set 122 generated in step S4 (step S5). Then, search condition derivation unit 160 derives, as a search condition, a value of explanatory variable x for obtaining a target value of target variable y from a search range acquired in step S1 by using prediction model 123 generated in step S5 (step S6). For example, search condition derivation unit 160 derives a value of explanatory variable x with which a value of target variable y is maximum or minimum.

Next, apparatus controller 170 sets, in material processing apparatus 200, a value of explanatory variable x, which is a search condition derived in step S6, and causes material processing apparatus 200 to perform processing according to the value of explanatory variable x, that is, mixing of the first liquid and the second liquid. As a result, data set update unit 110 acquires the value of explanatory variable x from apparatus controller 170, and acquires, from material processing apparatus 200, a value of target variable y obtained by mixing according to the value of explanatory variable x and process data. That is, data set update unit 110 acquires, as an actually measured value, a combination including the value of explanatory variable x and the value of target variable y (step S7).

Next, data set update unit 110 determines whether or not the value of target variable y included in the actually measured value acquired in step S7 reaches the target value acquired in step S1 (step S8). For example, in a case where the target value is a lower limit value, if the value of target variable y is equal to or more than the lower limit value, data set update unit 110 determines that the value of target variable y reaches the target value. Alternatively, in a case where the target value is an upper limit value, if the value of target variable y is less than or equal to the upper limit value, data set update unit 110 determines that the value of target variable y reaches the target value. Here, when determining that the value of target variable y does not reach the target value (No in step S8), data set update unit 110 updates data set 121 stored in storage unit 120 (step S9). That is, data set update unit 110 adds the combination including the value of explanatory variable x and the value of target variable y acquired in step S7 to data set 121. Then, search device 100 repeatedly executes the processing from step S3 after the processing of step S9.

On the other hand, when determining that the value of target variable y reaches the target value in step S8 (Yes in step S8), data set update unit 110 outputs the value of explanatory variable x acquired in step S7, and ends the search for explanatory variable x. In outputting the value of explanatory variable x, data set update unit 110 may cause a display device connected to search device 100 to display the value, or may store the value in storage unit 120. Alternatively, data set update unit 110 may transmit the value to a device outside search device 100 via the above-described communication interface.

As described above, in the present exemplary embodiment, data set 121 is processed based on confidence value r of target variable y, and prediction model 123 is generated using data set 121 that is processed. For this reason, for example, influence of a value of target variable y having small confidence value r on generation of prediction model 123 can be suppressed, and influence of a value of target variable y having large confidence value r on generation of prediction model 123 can be increased. As a result, even when a process for processing a raw material is unstable, that is, even in a case where an unreliable value of target variable y is obtained, prediction model 123 with high prediction accuracy can be generated. As a result, even in such a case, it is possible to perform an efficient search for a value of explanatory variable x by using prediction model 123. Further, a speed of a search can be increased.

Furthermore, in the present exemplary embodiment, a training amount for generating prediction model 123 by machine learning is weighted according to confidence value r. For this reason, for example, influence of a value of target variable y having small confidence value r on machine learning can be suppressed, and influence of a value of target variable y having large confidence value r on machine learning can be increased. That is, overfitting with respect to a value of target variable y having small confidence value r can be suppressed. Therefore, prediction model 123 with high prediction accuracy can be appropriately generated by machine learning.

Further, in the present exemplary embodiment, by the weighting described above, processed data set 122 includes, for each existing combination included in data set 121, additional combinations as many as the number corresponding to confidence value r, each including the same value of explanatory variable x as the existing combination. As a result, since the number of combinations can be adjusted according to confidence value r, for example, influence of a value of target variable y having small confidence value r on the machine learning can be effectively suppressed, and influence of a value of target variable y having large confidence value r on the machine learning can be effectively increased. That is, overfitting with respect to a value of target variable y having small confidence value r can be effectively suppressed. Therefore, prediction model 123 with high prediction accuracy can be more appropriately generated by machine learning.

Further, in the present exemplary embodiment, for example, a value of target variable y having small confidence value r included in an existing combination is replaced with another value different from the value and included in a new combination. Therefore, overfitting with respect to the value of target variable y having small confidence value r can be more effectively suppressed.

Further, in the present exemplary embodiment, confidence value r indicating a smaller value is calculated as variation of a value indicated by process data is greater, and the number of combinations is changed to a larger number as confidence value r is larger. By the above, overfitting with respect to target variable y having small confidence value r can be effectively suppressed.

Further, in the present exemplary embodiment, a new value of target variable y included in each of a plurality of new combinations is selected according to probability distribution having a value of target variable y included in an existing combination as an average. By the above, a value of target variable y included in an existing combination can be appropriately replaced with another value different from the value and included in a new combination.

Furthermore, in the present exemplary embodiment, normal distribution is used as probability distribution, and a new value of target variable y is randomly selected according to the normal distribution. By the above, a value of target variable y included in an existing combination can be more appropriately replaced with another value different from the value and included in a new combination.

Further, in the present exemplary embodiment, normal distribution having smaller variance is used as confidence value r is larger. By the above, for example, a value of target variable y having small confidence value r included in an existing combination can be replaced with another value greatly different from the value and included in a new combination, and a value of target variable y having large confidence value r can be replaced with another value close to the value and included in a new combination. Therefore, overfitting with respect to a value of target variable y having small confidence value r can be further effectively suppressed.

### OTHER MODIFICATION EXAMPLES

While search device 100 according to an aspect of the present disclosure is described above based on the exemplary embodiment, the present disclosure is not limited to the exemplary embodiment. Various modifications made on the above exemplary embodiment by those skilled in the art may be included in the present disclosure, as long as such modifications do not depart from the spirit of the present disclosure.

For example, in the above exemplary embodiment, a ratio of confidence value r is used to calculate the number of additional combinations, but the number of additional combinations may be calculated without using the ratio. For example, the number of additional combinations may be calculated by multiplying confidence value r by a predetermined coefficient. Alternatively, the number of additional combinations may be calculated by inputting confidence value r into a predetermined function. In this function, as input confidence value r is larger, a larger value is output as the number of additional combinations. Further, in the above exemplary embodiment, the square of process abnormality degree σ is used as variance of normal distribution, but variance of normal distribution does not need to be the square of process abnormality degree σ. Variance of normal distribution may be any value as long as the value is larger as process abnormality degree σ is higher.

Furthermore, prediction model 123 according to the above exemplary embodiment may be any model as long as the model indicates a relationship between an explanatory variable and a target variable, that is, a correlation relationship.

Note that each component in the above exemplary embodiment may be implemented by a piece of dedicated hardware or may be achieved by executing a software program suitable for the component. Each component may be implemented by a program execution unit such as a CPU or a processor reading and executing a software program recorded in a recording medium such as a hard disk or a semiconductor memory. Here, software that implements search device 100 and the like of the above-described exemplary embodiment is a program that causes a computer to execute each step of the flowchart illustrated in FIG. 13, for example.

Note that the following cases are also included in the present disclosure.

(1) The at least one device is specifically a computer system including a microprocessor, a read only memory (ROM), a random access memory (RAM), a hard disk unit, a display, a keyboard, a mouse, and the like. The RAM or the hard disk unit stores a computer program. The microprocessor operates in accordance with the computer program, so that the at least one device achieves its functions. Here, the computer program is configured by combining a plurality of instruction codes indicating commands to a computer in order to achieve a predetermined function.

(2) A part or all of the components constituting the at least one device may include one system large scale integration (LSI). The system LSI is a super multifunctional LSI manufactured by integrating a plurality of component portions on one chip, and is specifically a computer system including a microprocessor, a ROM, a RAM, and the like. The RAM stores a computer program. By a microprocessor operating in accordance with the computer program, the system LSI achieves its functions.

(3) A part or all of components constituting the at least one device may be constituted by an IC card detachable from the device or a single module. The IC card or the module is a computer system including a microprocessor, a ROM, a RAM, and the like. The IC card or the module may include the above-described super multifunctional LSI. The microprocessor operates in accordance with a computer program, so that the IC card or the module achieves its function. The IC card or the module may have tamper resistance.

(4) The present disclosure may be the methods described above. Further, the present disclosure may be a computer program causing a computer to implement these methods, or may be a digital signal including a computer program.

Further, the present disclosure may be a computer program or a digital signal recorded in a computer-readable recording medium such as a flexible disk, a hard disk, a compact disc (CD)-ROM, a DVD, a DVD-ROM, a DVD-RAM, a Blu-ray (registered trademark) disc (BD), or a semiconductor memory. Further, the present disclosure may be a digital signal recorded in these recording media.

Further, the present disclosure may be a computer program or a digital signal transmitted via a telecommunications line, a wireless or wired communication line, a network represented by the Internet, data broadcasting, or the like.

Further, the present disclosure may be carried out by another independent computer system by recording, on a recording medium, and transferring a program or a digital signal, or by transferring a program or a digital signal via a network or the like.

### INDUSTRIAL APPLICABILITY

The search device of the present disclosure can be applied to, for example, a device and a system that search for a processing condition for generating a product having a desired characteristic value as a search condition.

### REFERENCE MARKS IN THE DRAWINGS

100: search device
110: data set update unit
120: storage unit
121: data set
122: processed data set
123: prediction model
130: confidence value calculation unit
140: data set processing unit
150: prediction model generation unit
160: search condition derivation unit
170: apparatus controller
200: material processing apparatus
210: first liquid supply unit
211: first liquid container
212: first liquid pump
213: first liquid flow path
220: second liquid supply unit
221: second liquid container
222: second liquid pump
223: second liquid flow path
230: mixing flow path unit
240: process data acquisition unit
250: target variable acquisition unit
260: collection unit
1000: search system

1. A search device comprising:
a data set update unit that generates or updates a data set indicating a target variable and an explanatory variable in association with each other, the target variable indicating a characteristic value of a product obtained by processing by a material processing apparatus, the processing being performed on a raw material according to the explanatory variable;
a confidence value calculation unit that calculates a confidence value of the target variable based on process data obtained from the material processing apparatus, the process data indicating a state of the raw material during the processing;
a data set processing unit that processes the data set based on the confidence value;
a prediction model generation unit that generates a prediction model by using a processed data set that is the data set that is processed, the prediction model indicating a relationship between the explanatory variable and the target variable; and
a search condition derivation unit that derives, as a search condition, a value of the explanatory variable for obtaining a target value of the target variable, the deriving being performed by a search using the prediction model.

2. The search device according to claim 1, wherein
the prediction model generation unit generates the prediction model by machine learning using the processed data set, and
the data set processing unit processes the data set by weighting, according to the confidence value, a training amount that is number of combinations of a value of the explanatory variable and a value of the target variable.

3. The search device according to claim 2, wherein
the confidence value calculation unit calculates, for each existing combination that is one of the combinations included in the data set, a confidence value of a value of the target variable based on the process data when a value of the target variable included in the existing combination is obtained, and
the data set processing unit weights the training amount by changing, according to the confidence value, number of the combinations including a value of the explanatory variable corresponding to the confidence value for each confidence value.

4. The search device according to claim 3, wherein
the data set processing unit includes, when generating a plurality of new combinations from the existing combinations due to increase in number of the combinations, a value different from a value of the target variable as a new value of the target variable, instead of the value of the target variable included in the existing combination, in each of at least one of the plurality of new combinations.

5. The search device according to claim 4, wherein
the confidence value calculation unit calculates the confidence value indicating a smaller value as variation of a value indicated by the process data is greater, and
the data set processing unit changes number of the combinations by increasing number of the combinations as the confidence value is larger.

6. The search device according to claim 5, wherein
the data set processing unit selects a new value of the target variable included in each of the plurality of new combinations according to probability distribution having a value of the target variable included in the existing combination as an average.

7. The search device according to claim 6, wherein
the data set processing unit uses normal distribution as the probability distribution, and randomly selects a new value of the target variable according to the normal distribution.

8. The search device according to claim 7, wherein
the data set processing unit uses the normal distribution having smaller variance as the confidence value is larger.

9. A search method using a computer, the search method comprising:
generating or updating a data set indicating a target variable and an explanatory variable in association with each other, the target variable indicating a characteristic value of a product obtained by processing by a material processing apparatus, the processing being performed on a raw material according to the explanatory variable;
calculating confidence value of the target variable based on process data obtained from the material processing apparatus, the process data indicating a state of the raw material during the processing;
processing the data set based on the confidence value;
generating a prediction model by using a processed data set that is the data set that is processed, the prediction model indicating a relationship between the explanatory variable and the target variable; and
deriving, as a search condition, a value of the explanatory variable for obtaining a target value of the target variable, the deriving being performed by a search using the prediction model.

10. A program that causes a computer to execute:
generate or update a data set indicating a target variable and an explanatory variable in association with each other, the target variable indicating a characteristic value of a product obtained by processing by a material processing apparatus, the processing being performed on a raw material according to the explanatory variable;
calculate confidence value of the target variable based on process data obtained from the material processing apparatus, the process data indicating a state of the raw material during the processing;
process the data set based on the confidence value;
generate a prediction model by using a processed data set that is the data set that is processed, the prediction model indicating a relationship between the explanatory variable and the target variable; and
derive, as a search condition, a value of the explanatory variable for obtaining a target value of the target variable, the deriving being performed by a search using the prediction model.
